(19) United States
(12) Patent Application Publication
(10) Pub. No.: US 2020/0029749 A1
(43) Pub. Date: Jan. 30, 2020

(54) FOOT CARE PRODUCTS AND METHODS OF USE

(71) Applicant: Jason Wade, Gilbert, AZ (US)

(72) Inventor: Jason Wade, Gilbert, AZ (US)

(21) Appl. No.: 16/536,315

(22) Filed: Aug. 9, 2019

Related U.S. Application Data
(63) Continuation-in-part of application No. 15/563,505, filed on Sep. 29, 2017.
Application No. 15/563,505 is a continuation of application No. 62/078,789, filed on Nov. 12, 2014.
(60) Provisional application No. 62/120,033, filed on Feb. 24, 2015.

(51) Int. Cl. A47K 7/02; A61H 35/00; A47K 7/03

(52) U.S. Cl. CPC A47K 7/026; A61H 35/006; A47K 7/03; A61H 2201/0115; A61H 2201/164; A61H 2201/013; A61H 2205/12

(57) ABSTRACT

Foot care devices include a body having a concave recessed upper surface and an opposing lower surface. The upper surface has a foot treatment element connected to the body. The foot treatment element has a concave recessed configuration corresponding to the upper surface and a porous element attached to the upper surface. An immobilizing element is connected to the lower surface. The immobilizing element includes a plurality of movement-inhibiting suction members adapted to be attached to a surface and to inhibit positional movement of the body about the surface. The foot care device can include a cleansing compound embedded in the porous element and at least one hole configured to channel the liquid within the porous element.

This application claims the benefit of and is a continuation-in-part of U.S. application Ser. No. 15/563,505 filed Feb. 8, 2018, which is a continuation of provisional application No. 62/078,789 filed Nov. 12, 2014 and provisional application No. 62/120,033 filed Feb. 24, 2015. The entire disclosures of the prior applications are hereby incorporated by reference.

### BACKGROUND

### Technical Field

The present disclosure relates generally to foot care products, and more specifically to hands-free foot care devices and methods of using the same. In particular, present disclosure relates a substantially, positionally immobilizable, and/or hands-free foot care device.

### Related Technology

Foot care includes cleaning, washing, scrubbing, exfoliating, massaging, deodorizing, and otherwise treating the feet. Foot care, as an industry, occupies a unique space in the economy of developed countries. Pedicures, in particular, are offered as one of a number of luxury spa services that can cost recipients hundreds of dollars per treatment.

Recent trends in foot care include foot care products and devices for at-home or personal use. Such products and devices may provide the convenience of on-demand foot care and cost savings associated with do-it-yourself services. However, existing personal foot care products often fail to reach the level of convenience, performance, and value expected by consumers; even given the reduced cost of purchasing such products and devices. For instance, some existing foot care devices require a small, foot-sized tub of water to be filled prior to each use. In such systems, water can slosh and spill on the floor surrounding the tub.

Other products include hand-held foot-scrubbing devices for cleaning or exfoliating large surfaces of the feet. Such devices inconveniently require the use of hands in caring for feet Likewise, a user must either sit down and scrub the feet or stand and try to balance long enough to perform the same. This can be especially problematic in the shower and other surfaces where water on the floor may cause the user to slip and fall. Existing hands-free devices require the user to exert substantial effort sliding, twisting, and grinding their feet against product. In addition, existing devices may be subject to water or water-related damage, such as warping, mildew formation, etc.

Accordingly, there are a number of disadvantages in conventional foot care devices and products that can be addressed. Thus, there is a continuing need for a personal foot care device configured for at-home, in-shower use and/or that provides surface stability, hands-free use, and thorough cleaning of all areas of the feet and toes, without the cost associated with luxury spa treatment services.

### BRIEF SUMMARY

Implementations of the present disclosure overcome or solve one or more of the foregoing or other problems in the art with foot care devices having a body, a foot treatment element connected to the body, and/or a surface-stabilizing and/or immobilizing element connected to the foot treatment element. For instance, an implementation can include a foot care device comprising a body having one or more suction or friction members connected to a bottom surface thereof and a foot treatment element connected to a top surface thereof. The body can comprise a housing connected to a base plate. It will be appreciated, that the device can comprise a non-electric and/or stationary device.

The foot treatment element can be removably attached to the upper surface of the housing and can have exfoliating pumice, massaging protuberances, and/or cleaning bristles. The base can have or comprise one or more surface stabilizing platforms that extend outward relative to the housing and/or suction or friction members that secure the base to a surface. Alternatively, an immobilizing element can be connected to the bottom surface of the base, the immobilizing element having or comprising the surface stabilizing platforms and/or surface immobilizing suction or friction members. Certain implementations include kits with replaceable foot treatment elements and/or methods of treating feet with a foot care device or kit of the present disclosure.

Additional features and advantages of exemplary implementations of the disclosure will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of embodiments of the present disclosure can be obtained, a more particular description of the embodiments briefly described above will be rendered by reference to the specific embodiments, which are illustrated in the appended drawings. Understanding that these drawings depict only typical embodiments of the present disclosure and are not therefore to be considered to be limiting of the scope of the invention, the embodiments will be described and explained with additional specificity and detail through the use of the accompanying drawings in which:

FIG. 1 illustrates a front perspective view of an exemplary foot care device in accordance with an implementation of the present disclosure;

FIG. 2 illustrates an exploded view thereof;

FIG. 3 illustrates a bottom exploded view of an assembly thereof;

FIG. 4 illustrates a perspective view of various components of a foot care device in accordance with an implementation of the present disclosure; and

FIG. 5 illustrates a perspective view of an exemplary foot treatment element in accordance with an implementation of the present disclosure.

### DETAILED DESCRIPTION

Before describing various embodiments of the present disclosure in detail, it is to be understood that this disclosure is not limited to the parameters of the particularly exemplified systems, methods, apparatus, products, processes, and/or kits, which may, of course, vary. Thus, while certain embodiments of the present disclosure will be described in detail, with reference to specific configurations, parameters, components, elements, etc., the descriptions are illustrative and are not to be construed as limiting the scope of the claimed invention. In addition, the terminology used herein is for the purpose of describing the embodiments, and is not necessarily intended to limit the scope of the claimed invention.

Unless defined otherwise, all technical and scientific terms used herein have the same meaning as commonly understood by one of ordinary skill in the art to which the present disclosure pertains.

Various aspects of the present disclosure, including devices, systems, and methods may be illustrated with reference to one or more embodiments or implementations, which are exemplary in nature. As used herein, the term “exemplary” means “serving as an example, instance, or illustration,” and should not necessarily be construed as preferred or advantageous over other embodiments disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” and “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

It will be noted that, as used in this specification and the appended claims, the singular forms “a,” “an” and “the” include plural referents unless the context clearly dictates otherwise. Thus, for example, reference to a “bristle” includes one, two, or more bristles. Similarly, reference to a plurality of referents should be interpreted as comprising a single referent and/or a plurality of referents unless the content and/or context clearly dictate otherwise. Thus, reference to “bristles” does not necessarily require a plurality of such bristles. Instead, it will be appreciated that independent of conjugation; one or more bristles are contemplated herein.

As used herein, directional terms, such as “top,” “bottom,” “left,” “right,” “up,” “down,” “upper,” “lower,” “proximal,” “distal” and the like are used herein solely to indicate relative directions and are not otherwise intended to limit the scope of the disclosure and/or claimed invention.

Various aspects of the present disclosure can be illustrated by describing components that are bound, coupled, attached, connected, and/or joined together. As used herein, the terms “bound;” “coupled,” “attached,” “connected;” and/or “joined” are used to indicate either a direct association between two components or, where appropriate, an indirect association with one another through intervening or intermediate components. In contrast, when a component is referred to as being “directly bound;” “directly coupled,” “directly attached,” “directly connected,” and/or “directly joined” to another component, no intervening elements are present or contemplated. Furthermore, binding, coupling, attaching, connecting, and/or joining can comprise mechanical and/or chemical association.

To facilitate understanding, like reference numerals (i.e., like numbering of components and/or elements) have been used, where possible, to designate like elements common to the figures. Specifically, in the exemplary embodiments illustrated in the figures, like structures, or structures with like functions, will be provided with similar reference designations, where possible. Specific language will be used herein to describe the exemplary embodiments. Nevertheless, it will be understood that no limitation of the scope of the disclosure is thereby intended. Rather, it is to be understood that the language used to describe the exemplary embodiments is illustrative only and is not to be construed as limiting the scope of the disclosure (unless such language is expressly described herein as essential). Furthermore, multiple instances of an element and or sub-elements of a parent element may each include separate letters appended to the element number. Furthermore, an element label with an appended letter can be used to designate an alternative design, structure, function, implementation, and/or embodiment of an element or feature without an appended letter Likewise, an element label with an appended letter can be used to indicate a sub-element of a parent element. However, element labels including an appended letter are not meant to be limited to the specific and/or particular embodiment(s) in which they are illustrated. In other words, reference to a specific feature in relation to one embodiment should not be construed as being limited to applications only within said embodiment.

It will also be appreciated that where multiple possibilities of values or a range of values (e.g., less than, greater than, at least, or up to a celtain value, or between two recited values) is disclosed or recited, any specific value or range of values falling within the disclosed range of values is likewise disclosed and contemplated herein.

The headings used herein are for organizational purposes only and are not meant to be used to limit the scope of the description or the claims.

The present disclosure extends to foot care or treatment devices or kits, and to methods of using the same. In particular, certain embodiments include a surface securable and/or positionally immobilizable foot treatment device. The foot care device can be configured for personal, at-home, hands-free use or operation. The foot care device can be configured for use in or around water or other liquids (e.g., for use in the shower, bathtub, spa, hot tub, swimming pool, etc.). For instance, the foot care device can be water-tight, waterproof, and/or submergible (i.e., operational while submerged in liquid). In addition, the fool care device can have a hands-free and/or foot-operable configuration. For instance, the foot care device can be (wet or dry) surface adherable (or securable), substantially (positionally) immobilizable, and/or foot-engageable. Certain implementations comprise a kit that includes a foot treatment device with replaceable fool treatment elements. Implementations also include methods of treating feet with a foot care device or kit of the present disclosure.

Certain embodiments of a foot care device can generally include a foot treatment element and one or more movement-inhibiting elements. The movement-inhibiting element can comprise a surface-stabilizing element and/or a surface immobilizing element, and can also be connected to the foot treatment element to substantially inhibit positional movement of the foot treatment element. For instance, the foot care device can include a selectively engageable body having one or more suction and/or friction members connected to a bottom surface thereof and a foot treatment element connected to a top surface thereof. The device can also include one or more surface-stabilizing foot platforms extending outwardly from the body.

In at least one embodiment, the body can comprise a body. The body can comprise a housing having an encircling wall that at least partially bounds a (water-tight and/or waterproof) cavity.

In at least one embodiment, the covering element can comprise a base (plate) attached to the housing (e.g., at a lower edge surface thereof). The base can have an upper surface attached to the housing to cover the opening, and a lower surface opposite the upper surface (e.g., separated by a base height). In certain embodiments, the base plate can be reversibly attached or secured to the housing and/or lower edge surface thereof. In other embodiments, however, the base plate can be adhered, welded, and/or formed to the housing and/or lower edge surface thereof. Some embodiments can also include a sealing element, such as a (polymeric and/or waterproof) gasket, O-ring, seal, etc. The sealing element can be disposed at least partially between the covering element and the housing (e.g., to create a water-tight and/or sealed cavity. For instance, in certain embodiments, the base and/or housing can include a groove for seating the sealing element therein.

In some embodiments, the body, housing, wall, and/or an exterior surface thereof can include an upper receiving area. The receiving area and/or an upper treatment surface thereof can comprise a generally, substantially, and/or at least partially recessed or concave surface and/or configuration. For instance, the surface and/or configuration can be U-shaped and/or comprise a bottom surface and two side walls or surfaces (e.g., extending vertically upward from the bottom surface). The side walls can slope (gradually) or can have a sharp and/or angled configuration. Alternatively, the generally, substantially, and/or at least partially concave surface and/or configuration can be J-shaped, L-shaped configuration (e.g., with only one side wall), etc.

The body or body, housing, wall, exterior surface, and/or receiving area thereof, can have one or more foot treatment elements connected thereto and/or extending therefrom and/or an attachment element for securing the fool treatment element thereto. For instance, the attachment element can comprise one or more sockets for receiving attachment posts extending from the foot treatment element. The socket and post configuration can produce a substantially secured, reversibly attachable connection in certain embodiments. Other forces, however (e.g., user pulling forces, etc.) can reversibly separate the foot treatment element from the treatment assembly.

The treatment assembly can also comprise a connection element or component (e.g., for attaching the body to the treatment assembly). For instance, the body can include one or more attachment members for reversibly connecting the treatment assembly to the surface-stabilizing element(s) and/or surface immobilizing element(s).

In another embodiment, the body can comprise one or more side (towers) (e.g., extending vertically upward from the base element). The tower(s) can have one or more foot treatment elements (e.g., comprising an exfoliating element, massaging element, plurality of bristles, etc.) extending therefrom (e.g., from one or more surfaces). The tower(s) can also have a selective operation mechanism (e.g., on-off 25 switch or push button). In another embodiment, the body can comprise a single and/or central tower having one or more foot treatment elements (e.g., extending from opposing sides (and, optionally, a front surface) thereof).

The foot care device can include at least one movement-inhibiting element. The movement-inhibiting element(s) can comprise a base member connected (directly or indirectly) to the body (or the body, base, or lower surface thereof). The at least one movement-inhibiting element can be configured to secure the body to a surface (e.g., floor) and/or inhibit positional movement of the body about the surface. For instance, the movement-inhibiting element can have or comprise a surface or positional immobilizing element and/or a surface-stabilizing element.

The surface or positional immobilizing element can comprise one or more suction or friction members extending from the bottom surface of the movement-inhibiting element. Alternatively, the suction or friction members can be connected to the lower surface of the treatment assembly (or the body or base thereof).

The surface stabilizing element can comprise one or more surface stabilizing members extending (radially and/or laterally outwardly) from treatment assembly (or the body or base thereof). For instance, stabilizing member can comprise one or more (foot) platforms configured to have a force applied thereto to promote stability or reduce movement of the device about the surface. In some embodiments, the force can comprise pressure applied by at least one foot of a user. In an alternative embodiment, the at least one surface stabilizing element can extend (directly or indirectly) from the body or base of the treatment assembly. The movement-inhibiting element or surface stabilizing element(s) thereof can also include one or more gripping elements (e.g., on the upper surface and/or lower surface thereof, or on the upper surface and/or lower surface of the platforms).

In some embodiments, the movement-inhibiting element or surface stabilizing element(s) thereof can also have one or more foot treatment elements attached or connected thereto or extending therefrom (e.g., to an upper surface thereat). For instance, the base can include at least one exfoliating element and/or one or more bristles, brushes, fibers, etc. (e.g., connected to and/or extending from the (upper) surface(s) thereof).

Embodiments of the present disclosure include one or more foot treatment elements. The foot treatment element can be connected to and/or extend from the body, housing, wall, exterior surface, and/or receiving area thereof. The foot treatment element(s) can comprise an exfoliating element (e.g., natural or synthetic pumice), a massaging element (e.g., elastomeric protuberances) and/or cleaning (or brushing) element (e.g., bristles of one or more lengths, gauges, and/or densities), which can be attached to a surface of a body. Alternatively, the foot treatment element(s) can comprise a removable insert (e.g., plate member) reversibly attached to the surface of a body or receiving area thereof. The insert can be or have a shape or configuration corresponding to and/or suitable for attachment to the body or receiving area thereof. For instance, the insert can have a generally, substantially, and/or at least partially recessed or concave surface and/or configuration (e.g., a U-shaped, J-shaped, or L-shaped configuration).

As used herein, reference to “pumice” can include natural and/or synthetic pumice. Other exfoliating elements (e.g., particulate and/or crystalline-embedded material) and/or (dead) skin removal elements (e.g., razor(s), blade(s), grater(s), file(s), etc.) are also contemplated herein. Similarly, the massaging element or elastomeric protuberances can comprise silicone, rubber, or other material configured to provide a comfortable skin contact. The cleaning element can alternatively comprise a sponge, loofah, or other skin cleansing member.

One or more embodiments of the present disclosure comprise a kit that includes a plurality of interchangeable foot treatment elements. For instance, certain kits can include two or more (replaceable) inserts. The inserts, respectively, can include an exfoliating element, massaging element, and/or cleaning element. In certain embodiments, the kit can include at least one inselt having an exfoliating element, at least one insert having a massaging element, and/or at least one insert having a cleaning or brushing element.

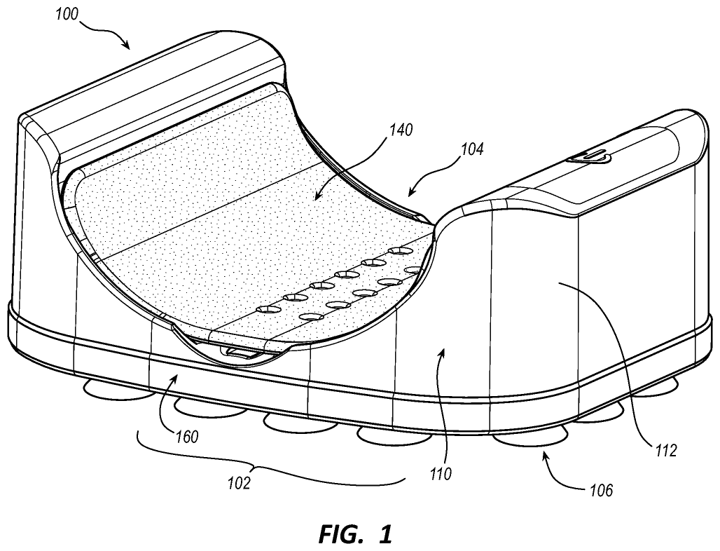

Referring now to the figures, one or more implementations of the present disclosure comprise a foot care device configured for treating feet (e.g., in the shower). For example, FIG. 1 illustrates a perspective view of an illustrative foot care device 100 according to one implementation of the present disclosure. Foot care device 100 has an upper treatment area 104 and a lower surface attachment area 106. Foot care device 100 comprises a treatment assembly 102 and a foot treatment element 140 connected to treatment assembly 102. Treatment assembly 102 includes an upper body 110 (comprising a housing 112), and an immobilizing element 160 connected to a lower portion of upper body 110. Foot treatment element 140 is connected to an upper portion of upper body 110.

The various components of foot care device 100 will now be described in further detail. It will be appreciated that the various components of foot care device 100 can comprise and/or be formed of any suitable material(s), including without limitation, one or more metals or metal alloys, polymeric or plastic materials, and/or any other (naturally-occurring and/or synthetic) substance(s). For instance, in at least one embodiment, one or more components of foot care device 100 (e.g., immobilizing element 160 and/or component(s) thereof) can be comprised of one or more elastomeric, polymeric, rubberized, and/or other (flexible) materials (e.g., rubber, silicone, etc.). In certain embodiments, one or more components of foot care device 100 (e.g., upper body (or body) 110 and/or component(s) thereof) can be comprised of one or more substantially, partially, and/or semi-rigid materials (e.g., polymeric, plastic, polyethylene terephthalate (PET), polyethylene terephthalate with glycol-modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), cellulose-based polymers (cellulose acetate, cellulose butyrate or cellulose propionate), etc.). As discussed in further detail below, foot care device 100, or one or more components thereof, can also comprise a waterproof, water-tight, or water-resistant material and/or configuration in certain embodiments.

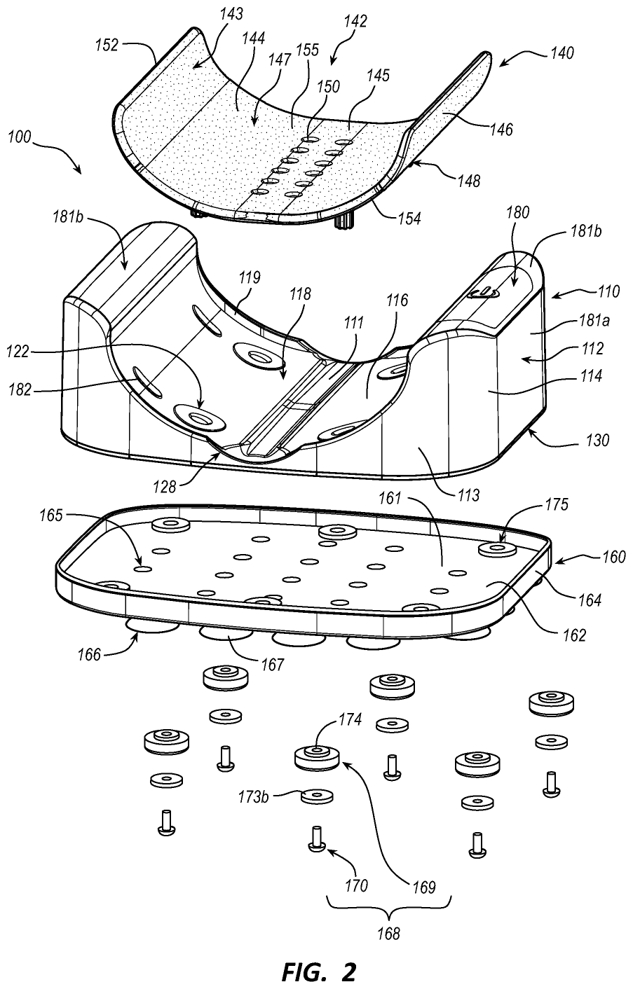

FIG. 2 illustrates an exploded view of foot care device 100. The body 110 comprises a housing 112 and a base (or plate) 130 connected to the housing 112. Housing 112 comprises a wall 113 having an outer surface 114. Housing 112 or wall 113 thereof also has or comprises opposing sides or side towers 181a, each having an upper portion 181b. A wall 113 also includes a lower edge extending between outer surface 114 and an inner surface at a lower edge of wall 113 (or body 110 or housing 112).

The body 110, or housing 112 thereof, or wall 113 thereof comprises upper surface 116 opposite the base 130. Upper surface 116 is disposed in a receiving area 118, configured for receiving foot treatment element 140. For instance, upper body 110, or upper surface 116 thereof includes a plurality of receiving elements 122. As described in further detail below, each receiving element 122 comprises a (recessed) socket configured for receiving the post of connection component 148 of foot treatment element 140, to thereby reversibly secure foot treatment element 140 to treatment assembly 102, or upper body 110 thereof, receiving elements 122 and connection component 148 comprising an attachment mechanism. Upper surface 116 also has a channel 111 extending from a first end (or front) thereof, to a second end (or back) thereof.

Upper body 110 also includes retaining wall 119 extending upwardly from outer surface 114 and/or upper surface 116. At least a portion of retaining wall 119 can extend upwardly beyond at least a portion of upper surface 116, such that when foot treatment element 140 is attached to upper body 110 or disposed in receiving area 118 thereof, as depicted in FIG. 1, retaining wall 119 at least partially retains foot treatment element 140 in receiving area 118. In addition, upper body 110 includes one or more buffering elements 182 (e.g., in receiving area 118 and/or attached to upper surface 116). Buffering elements 182 can be configured to reduce and/or inhibit (rattling) noises generated by (contact between) upper body 110 and foot treatment element 140.

Upper surface of base 130 can be mated with a lower edge of housing 112 and secured thereto by any suitable attachment mechanism. A pressure fit, snap fit, twist fit, locking fit, or other suitable mechanism known in the art may be employed to secure fasteners 170 to or within attachment elements 134.

In at least one embodiment, base 130 can seal the opening formed and/or defined by a lower edge of the housing 112. For instance, body 110 can also include sealing element, such as a seal, gasket, or O-ring configured to create a waterproof, water-tight, or water-resistant connection or seal between housing 112 and base 130. The housing can include a recess in a lower edge that is configured to receive at least a portion of sealing element therein. A tight seal (e.g., devoid of any water penetrating gaps or cracks) can be formed between housing 112 and base 130 (by means or virtue of sealing element). In addition, base 130 can include outer edge, which can be aligned and/or (substantially) flush with wall 113, or outer surface 114 thereof.

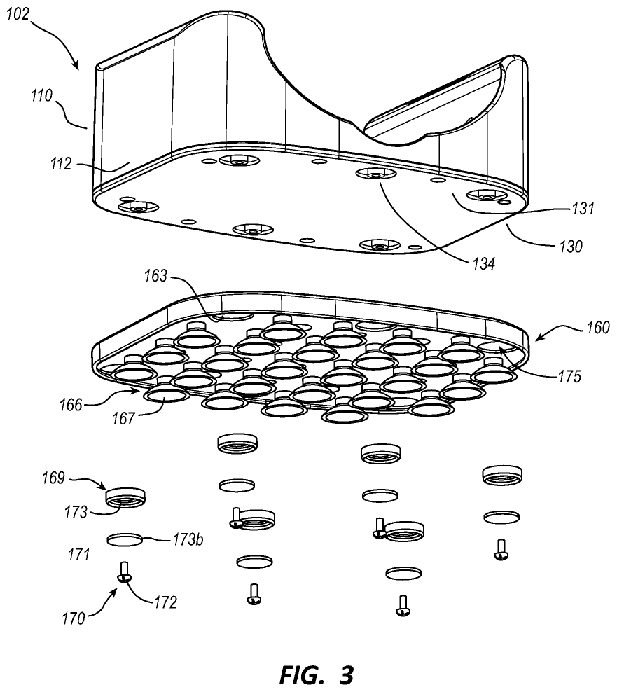

With reference to FIG. 3, immobilizing element 160 has an upper surface 162 and a lower surface 163 opposite upper surface 162. Immobilizing element 160 also includes a side wall 164 extending upwardly from and/or beyond upper surface 162. Side wall 164 and upper surface 162 at least partially bound a receiving area (or recess, socket, cavity, etc.) 161 (configured for receiving upper body 110 therein). Immobilizing element 160 also includes a plurality of through-holes 165 and a plurality of attachment openings 175 extending therethrough and/or from upper surface 162 to lower surface 163. Through-holes 165 can allow and/or ensure that any water or other fluid or material disposed in receiving area 161 can drain out thereof Attachment openings 175 provide a means for securing immobilizing element 160 to upper body 110 and/or base 130 thereof. Immobilizing element 160 can be (reversibly) connecting and/or attached to upper body 110 (or base 130 thereof) by means of attachment mechanism 168 (as illustrated in FIG. 1).

Attachment mechanism 168 includes a plurality of footings 169 and a plurality of corresponding fasteners 170. Fasteners 170 can be inserted through opening 174 of footings 169, through attachment opening 175 of immobilizing element 160, and into attachment element 134 of base 130. Fasteners 170 can comprise a head 172 and a shaft 171 connected thereto and/or extending therefrom. Footing 169 comprises a recess (socket) 173 for receiving head 172 upon insertion of shaft 171 through opening 174. In addition, a capping element 173b can be secured to footing 169 so as to cover recess 173 and/or conceal fastener 170 (or head 172 thereof). Fasteners 170 and/or shaft 171 thereof can be secured to or within attachment elements 134 (or opening 174 and/or recess 173 thereof) by any suitable mechanism. For instance, shaft 171 can have a threaded outer portion corresponding to a threaded inner portion of attachment elements 134. A pressure fit, snap fit, twist fit, locking fit, or other suitable mechanism known in the art may be employed to secure at least a portion of shaft 171 to or within attachment elements 134. Those skilled in the art will appreciate, however, that other suitable attachment mechanism 168 can be used (interchangeably) to secure immobilizing element 160 to upper body 110 or base 130 thereof.

Immobilizing element 160 also includes a movement-inhibiting element 166. Movement-inhibiting element 166 can be configured to attach and/or secure foot care device 100, treatment assembly 102 thereof, and/or immobilizing element 160 thereof to a support or attachment surface. Accordingly, movement-inhibiting element 166 can be disposed on, connected to, and/or extend from lower surface 163 of immobilizing element 160. As depicted herein, movement-inhibiting element 166 comprises a plurality of suction elements (or cups) 167 (e.g., extending from and/or disposed about lower surface 163 of immobilizing element 160). As understood by those skilled in the art, suction elements 167 can create negative pressure and/or (releasable) vacuum sufficient to (reversibly) attach and/or secure immobilizing element 160 to a variety of surface types. In particular, movement-inhibiting element 166 and/or suction dements 167 thereof can attach and/or secure immobilizing element 160 to tile, ceramic, marble, stone, wood, vinyl, linoleum, or other type of flooring or structural surface. In addition, movement-inhibiting element 166 and/or suction elements 167 thereof can attach and/or secure immobilizing element 160 to porcelain, fiberglass, or other type of shower, bathtub, spa, hot tub, swimming pool, or other structural surface.

FIG. 2 also illustrates foot treatment element 140. Foot treatment element 140 comprises an insert having an upper surface 144 and a lower surface 146 opposite upper surface 144. Upper surface 144 forms and/or defines a treatment area 142. Upper surface 144 and/or treatment area 142 thereof can have or comprise a recessed or concave configuration (e.g., substantially similar and/or corresponding to the concave configuration of receiving area 118. Indeed, as depicted herein, upper surface 144 and/or treatment area 142 thereof has a substantially U-shaped configuration. Foot treatment element 140 also includes connection component 148 disposed on and/or extending from lower surface 146, and an exfoliating element 155 disposed on and/or connected to upper surface 144. In the depicted embodiment, exfoliating element 155 comprises a synthetic pumice material disposed over (the entire) upper surface 144. In particular, upper surface 144 comprises opposing side portions 143 extending from opposite sides of bottom portion 145, and intermediate (sloping) portions 147 disposed between side portions 143 and bottom portion 145. Exfoliating element 155 extends from bottom portion 145, over intermediate portions 147, and up both side portions 143 to top edge 152. Those skilled in the art will appreciate, however, that exfoliating element 155 need not extend over the entire upper surface 144.

In the depicted embodiment, connection component 148 comprises a plurality of posts extending from lower surface 146. Foot treatment element 140 can be received in receiving area 118 by inserting the posts of connection component 148, respectively, into receiving elements 122. As a result, lower surface 146 is disposed against upper surface 116 as depicted in FIG. 2 (e.g., with buffering elements 182 disposed therebetween to reduce and/or inhibit rattling noises caused during operation of the movement generating mechanism). Similarly, side edge 154 of foot treatment element 140 can fit snugly against retaining wall 119. In at least one embodiment, the fit and/or contact between side edge 154 and retaining wall 119 can provide a force (e.g., friction, pressure, etc.) that at least partially retains foot treatment element 140 within receiving area 118. In addition, as indicated above, connection component 148 can cooperate with receiving elements 122 to at least partially retain foot treatment element 140 within receiving area 118. For instance, connection component 148 and receiving elemems 122 can form a partial locking fit. Alternatively, a pressure fit, snap fit, or other suitable mechanism known in the art may be employed to secure connection component 148 to or within receiving elements 122.

Those skilled in the art will appreciate that the socket and post configuration of the attachment mechanism comprised of receiving elements 122 and connection component 148 can produce a substantially secured, reversibly attachable connection between foot treatment element 140 and upper body 110. For instance, the connection can retain the attachment of foot treatment element 140 to upper body 110 under certain (mild) separating forces (e.g., gravity, etc.). Other forces, however (e.g., user pulling forces, etc.) can reversibly separate foot treatment element 140 from upper body 110.

Foot treatment element 140 and/or bottom portion 145 thereof also has a plurality of drain holes 150 extending therethrough. By connecting connection component 148 to receiving elements 122 (e.g., by insertion), drain holes 150 can become substantially aligned with channel 111, such that water or other fluid (and/or components disposed and/or suspended therein) can be drained through drain holes 150 and off of upper surface 116 (and/or out of receiving area 118) by means of channel 111. Thus, standing water or other fluid may be channeled away from receiving area 118 so as to attenuate and/or substantially prevent mildew, mold, or other undesirable drawbacks of fluid.

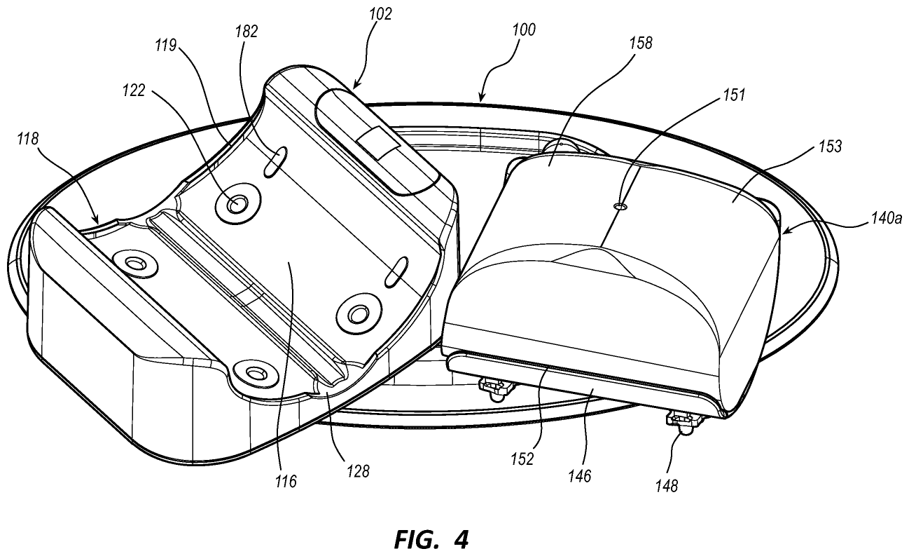

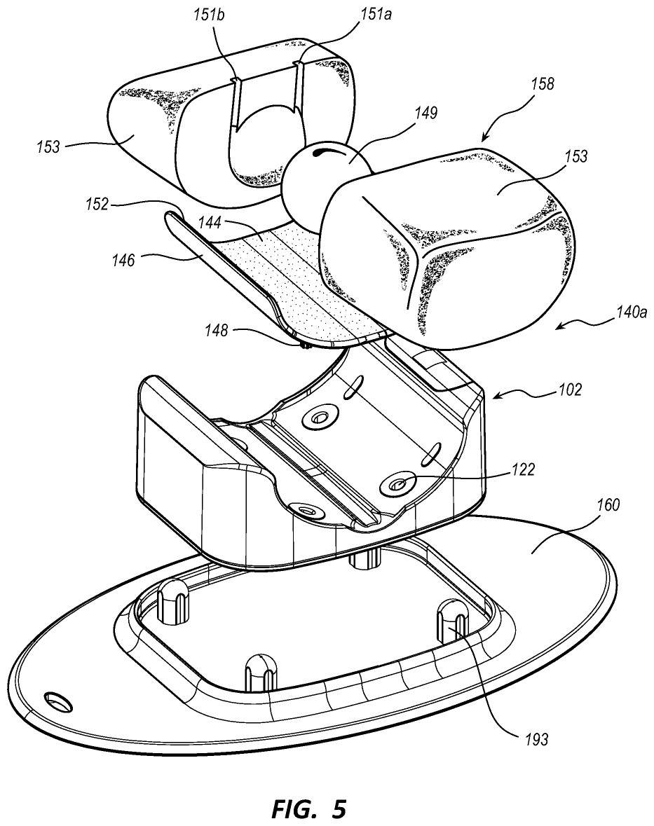

FIGS. 4 and 5 illustrate various embodiments of a foot care device 100 including treatment assembly 102 and foot treatment element 140a. For instance, foot treatment assembly 102 includes one or more of a foot treatment element 140, and a foot treatment element 140a. The foot treatment elements can be interchanged to selectively attach various foot treatment elements to the treatment assembly 102. The foot treatment elements can be configured to massage, cleanse or otherwise treat a foot. In one example, the foot treatment element 140a includes a cleansing element 158, such as a sponge, luffa or other soft porous element 153. The porous element 153 is attached to the upper surface 144 of the foot treatment element 140a. The foot treatment element 140a attaches to the treatment assembly 102, for instance, by inserting post connection components 148 to receiving elements 122. The fit between the post connection components 148 and receiving elements 122 can be configured to have a tight tolerance to press fit and hold the foot treatment element 140 snuggly against the upper surface 116 of the treatment assembly 102.

The porous element 153 can have a rectangular shape with rounded corners. The porous element is affixed to the upper surface 144 of the foot treatment element 140a and sized to fit between and extend above the top edge 152 and along the upper surface 144 of the foot treatment element 140a. The porous element 153 can include one or more holes 151. The hole 151 can be formed in the porous element 153 by drilling, molding or boring the hole 151 from one surface to an approximate mid-point in the porous element 153. The hole 151 is configured to apply liquids, such as essential oils, soaps, conditioners, treatment lotions and other skin care or foot care products. The liquids are inserted into the porous element 153 through the hole 151.

The foot treatment element 140a may also include a cleansing compound 149, such as a soap bar, soap ball or other solid mixture of skin care or foot care cleansing elements. The cleansing compound 149 is embedded into the porous element 153 by molding the cleansing compound 149 into the porous element 153. The porous element 153 can include one or more holes 151 formed from a surface partially through the porous element 153. In the example illustrated in FIG. 5, for instance, a first hole 151a and a second hole 151b are positioned on opposite sides of the cleansing compound 149. The holes 151a and 151b are configured to apply one or more liquids, such as essential oil, scented oils, conditioners, treatment lotions and other skin care or foot care products. The liquids can be inserted through the holes 151a and 151b to add other scents, skin care or foot care products to the cleansing compound 149 to embed the liquid within the porous element 153. The hole 151 can be formed to channel the liquid to the cleansing compound 149.

The cleansing compound 149 is formed into a shape such as a sphere, cuboid, cylinder, ellipsoid, or other three-dimensional shape. The cleansing compound 149 can then be place in the mold for the porous element 153 and suspended at the desired location within the porous element 153. Supports and be used to suspend the cleansing compound 149, which also can be used to form the holes 151 within the porous element 153 when removed from the mold. The cleansing compound 149 can be solid and molded within porous element 153 to completely surround the cleansing compound 149.

The immobilizing base 160 can include suction elements 167 to secure the foot treatment element 140 to a variety of surface types found in bath and show surfaces, such as tiles, plastics, ceramics, concrete and the like.

A foot care kit can include treatment assembly 102 and a plurality of interchangeable foot treatment element 140. For instance, foot care kit can include a first foot treatment element 140, a second foot treatment element 140a, as described above and/or various other foot treatment elements. For example, foot treatment elements can include a massaging element disposed on and/or connected to upper surface 144 of the foot treatment element. Those skilled in the art will appreciate, however, that massaging elements can be comprised of any suitable material(s) and any (number of) suitable massaging members or components. Similarly, in the depicted embodiment, foot treatment element 140a comprises a cleansing element 158. A cleansing element may include bristles of any suitable length, gauge, and/or density, or combination thereof. In at least one alternative embodiment can comprise a foot treatment element having two or more types of foot treatment members disposed on the foot treatment element 140.

Similarly, treatment assembly 102 utilizes an attachment mechanism 168 having a plurality of fasteners 170 extending through openings 174, respectively, of footings 169, through attachment openings 175 of immobilizing dement 160, and into attachment elements 134 of base 130 (as in treatment assembly 102), attachment mechanism 168 of treatment assembly 102 utilizes and/or includes a plurality of fasteners 170 extending from the lower surface 131 of base 130, through attachment opening 175 of immobilizing element 160, and into a receiving opening or socket 173 in footing 169, respectively. In addition, immobilizing element 160 includes side wall 164 that does not extend beyond the upper surface thereof. Accordingly, immobilizing element 160 does not include a recessed receiving area 161 as does immobilizing element 160. Instead, side wall 164 can be aligned and/or substantially flush with outer edge of base 130 and/or the exterior surface 114 of housing 112 (or wall 113 thereof) when treatment assembly 102 is assembled together.

A foot treatment element 140 may have an exfoliating element, a cleansing element including a plurality of bristles. In an alternative embodiment, cleansing element can be disposed on either side of exfoliating element. In such an embodiment, bristles may comprise bristles of a longer and/or softer length, gauge, and/or density. Accordingly, foot treatment element 140 can include a variety of different types of foot treatment members. In at least one embodiment, foot treatment element 140 and/or one or more component(s) thereof can be attached to body 110 and/or receiving area 118 so as to be substantially irremovable. For instance, foot treatment element 140 and/or one or more component(s) thereof can be attached to body 110 and/or receiving area 118 by means of an adhesive or other attachment mechanism configured to retain foot treatment element 140 and/or one or more component(s) thereof on the surface of upper body 110 and/or receiving area 118. However, foot treatment element 140 and/or one or more component(s) thereof can also be removably attached.

In some embodiments, immobilizing element 160 can comprise and/or be formed of one or more elastomeric, polymeric, rubberized, silicone, or other (flexible) materials. Accordingly, the texturing can comprise a textured surface of the material in certain embodiments. In other embodiments, immobilizing element 160 can comprise and/or be formed of one or more substantially, partially, and semi-rigid materials. In another embodiment, immobilizing element 160 can be formed of an upper piece and a lower piece that have been (thermo-) formed together, such as by heating (e.g., thermoforming), welding, and/or adhering (e.g., with one or more suitable adhesives).

One or more implementations can also include a method of using a foot treatment device of the present disclosure. The method can include providing a foot treatment device as disclosed herein. The method can include, placing the foot treatment device and on a floor or other support surface and applying an initial (securing and/or adhering) force to a portion of the foot treatment device (e.g., an immobilizing element or portion(s) thereof). The initial force can comprise downward pressure configured to secure the movement-inhibiting elements of the immobilizing element to the support surface. For instance, the user can press downward with one or more hands or feet on stabilizing element(s) (or stabilizing members thereof), foot treatment assembly body 110 (or receiving area and/or foot treatment element thereof, and/or the side tower(s) of the foot treatment device. The foot treatment device can thereby become secured to the support surface via the movement-inhibiting element(s) or members thereof.

After engaging the body, the user can slide the foot to be treated in one or more directions (e.g., forward and backward, side-to-side, rotationally, etc.) within the receiving area and/or about the foot treatment element. A first foot treatment element can be used to exfoliate the bottom and/or sides of the treatment foot. A second foot treatment element can be used to scrub, clean, and/or brush away the exfoliated skin of the treatment foot. A third foot treatment element can be used to massage the treatment foot.

In at least one implementation, the device can include a treatment assembly (e.g., connected to the upper surface of the base). The treatment assembly can comprise a platform having an upper surface and an opposing lower surface. The lower surface can be connected to the base and/or the upper surface can be connected to the body. In addition, a casing can cover the movement generating element and/or be connected to the upper and/or lower surface of the platform in some embodiments. Furthermore, one or more treatment elements can be connected to or extend from the upper surface of the platform, the upper surface of the casing, and/or one or more surfaces of the movement generating element.

One or more implementations of the present disclosure include a foot treatment device comprising a body having one or more surface-stabilizing or immobilizing elements attached to a lower surface thereof and foot treatment elements extending therefrom and/or attached to an upper surface thereof. For instance, one or more implementations of the present disclosure include a foot care device comprising a low-profile base element having one or more suction or friction members connected thereto (e.g., to a bottom surface thereof) and/or one or more fool treatment elements connected thereto (e.g., to a top surface thereof).

Certain implementations include a personal, at-home, hands-free, and/or in-shower, foot cleaning device having a body extending upwardly from the upper surface of a base. The base also has a plurality of short, scrubbing bristles and/or an exfoliating pumice stone extending upwardly from the upper surface thereof for cleaning and caring for the bottom of the feet. The base can have opposing foot platforms extending radially or laterally therefrom for securing the device in place while in use. The base can also have one or more suction cups on the undersurface thereof to prevent movement of the device along or about the floor of the shower.

The body can have long lateral bristles extending out from the left and right sides for cleaning the tops, back, and/or sides of the feet. The body can be selectively operable with a push-bottom on/off switch (e.g., on the top of the body). The body can also have cleaning bristles extending from the from side for cleaning the fronts and between the toes of the feet. These front bristles can also clean under toenails. The device can also include a soap or other product dispenser or cartridge that dispenses the product into the brushes or bristles such that the user does not need to bend over or lift the feet to apply soap thereto. The dispenser can also be operated by means of the on/off switch in some implementations.

Foot care device 100 and/or upper body 110b thereof also includes activation element 180. The activation element 180 can have a push button to release foot treatment care products or activate a feature of the foot care device 100. In some implementations, a soap dispenser can dispense soap automatically into the bristles upon engaging the device. Alternatively, a manual foot plunger or other device can be included for soap dispensing.

The user can then place the left foot on the left foot platform to hold the device in place with the help of the bottom-mounted suction cups distributed over the underside of the base. The right foot can then be cleaned and/or treated by thrusting the right foot forward and backwards through the brushes extending from the base and body. The toes can be cleaned by rubbing them against the front-facing bristles, with particular emphasis on brushing between the toes. Both sides of the right foot can be cleaned by alternating sides of the body. The pumice stone can also be used to scrub the bottoms of the right foot, including the heels, toes, and ball of the foot.

The left foot can similarly be cleaned and treated by placing the right foot on the right foot platform and proceeding in like manner. One will appreciate that many customizable variations in foot treatment become possible with embodiments of the present disclosure described herein. For instance, the proximity of the body to the various brushes makes an in-shower, scrubbing foot massage possible without the need for sitting down, lifting the feet, or even the use of hands.

The user can perform one or more of the foregoing methods in the shower, bathroom, home, or any other suitable location. In one or more embodiments, the foot treatment device can be placed on the floor of the shower. The user can then perform the method of treating a foot while showering and/or while the water of the shower is running. Accordingly, foot treatment devices of the present disclosure can be waterproof, water resistant, and/or suitable for use in the shower. One will appreciate however that foot care devices of the present disclosure need not be used only in the shower. For instance, the foot care devices of the present disclosure can be used on any suitable support surface.

Various alterations and/or modifications of the inventive features illustrated herein, and additional applications of the principles illustrated herein, which would occur to one skilled in the relevant art and having possession of this disclosure, can be made to the illustrated embodiments without departing from the spirit and scope of the invention as defined by the claims, and are to be considered within the scope of this disclosure. Thus, while various aspects and embodiments have been disclosed herein, other aspects and embodiments are contemplated. While a number of methods and components similar or equivalent to those described herein can be used to practice embodiments of the present disclosure, only certain components and methods are described herein.

It will also be appreciated that devices, products, kits, methods, and/or processes, according to certain embodiments of the present disclosure may include, incorporate, or otherwise comprise properties, features (e.g., components, members, elements, parts, and/or portions described in other embodiments disclosed and/or described herein. Accordingly, the various features of certain embodiments can be compatible with, combined with, included in, and/or incorporated into other embodiments of the present disclosure. Thus, disclosure of certain features relative to a specific embodiment of the present disclosure should not be construed as limiting application or inclusion of said features to the specific embodiment. Rather, it will be appreciated that other embodiments can also include said features, members, elements, parts, and/or portions without necessarily departing from the scope of the present disclosure.

Moreover, unless a feature is described as requiring another feature in combination therewith, any feature herein may be combined with any other feature of a same or different embodiment disclosed herein. Furthermore, various well-known aspects of illustrative systems, methods, apparatus, and the like are not described herein in particular detail in order to avoid obscuring aspects of the example embodiments. Such aspects are, however, also contemplated herein. The present disclosure may be embodied in other specific forms without departing from its spirit or essential characteristics. The described embodiments are to be considered in all respects only as illustrative and not restrictive. The scope of the invention is, therefore, indicated by the appended claims rather than by the foregoing description. While certain embodiments and details have been included herein and in the attached disclosure for purposes of illustrating embodiments of the present disclosure, it will be apparent to those skilled in the art that various changes in the methods, products, devices, and apparatus disclosed herein may be made without departing from the scope of the disclosure or of the invention, which is defined in the appended claims. All changes which come within the meaning and range of equivalency of the claims are to be embraced within their scope.

What is claimed is:

1. A foot care device, comprising:
an immobilizing element including a movement-inhibiting element attached across a base of the immobilizing element;
a treatment assembly connected to the immobilizing element, the treatment assembly including a housing body having an encircling wall with an exterior surface, an interior surface, and a lower edge surface extending between the exterior surface and the interior surface, the exterior surface having an upper receiving area; and
a foot treatment element attached to the treatment assembly in the receiving area, the foot treatment element having a porous element attached to the foot treatment element, the porous element having at least one hole formed partially through the porous element and configured to embed a liquid within the porous element.

2. The foot care device of claim 1, wherein the foot treatment element comprises a foot receiving area having an at least partially concave upper surface.

3. The foot care device of claim 2, further comprising an electrically operable, localized body; the foot treatment element connected to the body such that operation of the body causes localized movement of the foot treatment element.

4. The foot care device of claim 2, further comprising a lower base and an upper housing connected to the base, the base having an upper surface and an opposing lower surface, the immobilizing element being connected to the lower surface, the housing being connected to the upper surface, the housing comprising an encircling wall having an exterior surface, an interior surface, and a lower edge surface extending between the exterior surface and the interior surface, the interior surface partially bounding an internal cavity, the body being disposed within the cavity, the exterior surface having an upper receiving area, the foot treatment dement being attached to the housing at the receiving area, the lower edge being connected to the upper surface of the base, the lower edge having a cavity opening therein, the base substantially covering the cavity opening.

5. The foot care device of claim 4, further comprising an attachment mechanism detachably connecting the immobilizing element to the lower surface of the base such that the base and housing connected to the base can be reversibly detached from and reattached to the immobilizing element.

6. The foot care device of claim 1, wherein the porous element further comprises a cleansing compound embedded in the porous element and the at least one hole is configured to channel the liquid to the cleansing compound.

7. The foot care device of claim 1, wherein the foot treatment element is interchangeable to selectively attach various foot treatment elements to the housing body.

8. A foot care device, comprising:
a body having a concave recessed upper surface and an opposing lower surface, the upper surface having a foot treatment element connected to the body, the foot treatment element having a concave recessed configuration corresponding to the upper surface and a porous element attached to the upper surface; and
an immobilizing element connected to the lower surface, the immobilizing element comprising a plurality of movement-inhibiting suction members adapted to be attached to a surface and to inhibit positional movement of the body about the surface.

9. The foot care device of claim 8, wherein the porous element further comprises a cleansing compound embedded in the porous element.

10. The foot care device of claim 8, wherein the porous element further comprises at least one hole is configured to channel the liquid within the porous element.

11. The foot care device of claim 8, wherein the foot treatment element is interchangeable to selectively attach various foot treatment elements to the body.

12. The foot care device of claim 8, further comprising an electrically operable, localized body; the foot treatment element connected to the body such that operation of the body causes localized movement of the foot treatment element.

13. The foot care device of claim 12, further comprising a lower base and an upper housing connected to the base, the base having an upper surface and an opposing lower surface, the immobilizing element being connected to the lower surface, the housing being connected to the upper surface, the housing comprising an encircling wall having an exterior surface, an interior surface, and a lower edge surface extending between the exterior surface and the interior surface, the interior surface partially bounding an internal cavity, the body being disposed within the cavity, the exterior surface having an upper receiving area, the foot treatment dement being attached to the housing at the receiving area, the lower edge being connected to the upper surface of the base, the lower edge having a cavity opening therein, the base substantially covering the cavity opening.

14. The foot care device of claim 13, further comprising an attachment mechanism detachably connecting the immobilizing element to the lower surface of the base such that the base and housing connected to the base can be reversibly detached from and reattached to the immobilizing element.

15. The foot care device of claim 8, wherein the porous element further comprises a cleansing compound embedded in the porous element and the at least one hole is configured to channel the liquid to the cleansing compound.

16. A foot care device, comprising:
an immobilizing element including a plurality of movement-inhibiting suction members attached across a base of the immobilizing element and adapted to inhibit positional movement of the foot care device about an attached surface;
a treatment assembly connected to the immobilizing element, the treatment assembly having a concave recessed upper surface and an opposing lower surface; and
a foot treatment element attached to the upper surface of the treatment assembly in the receiving area, the foot treatment element having a porous element attached to the foot treatment element, the porous element having a solid cleansing compound molded within and completely surrounded by the porous element.

17. The foot care device of claim 16, wherein the porous element further comprises at least one hole is configured to channel the liquid to the cleansing compound within the porous element.

18. The foot care device of claim 16, wherein the foot treatment element is interchangeable to selectively attach various foot treatment elements to the treatment assembly.

19. The foot care device of claim 16, further comprising an electrically operable, localized body; the foot treatment element connected to the body such that operation of the body causes localized movement of the foot treatment element.
